(19) United States
(12) Patent Application Publication
(10) Pub. No.: US 2018/0209382 A1
(43) Pub. Date: Jul. 26, 2018

(54) MIXING DEVICE AND METHOD OF MAKING AND USING THE SAME

(71) Applicant: BorgWarner Inc., Auburn Hills, MI (US)

(72) Inventors: Mihai MICLEA-BLEIZIFFER, Worms (DE); Sascha KARSTADT, Undenheim (DE); Urs HANIG, Stuttgart (DE); Christopher THOMAS, Commerce, MI (US)

(21) Appl. No.: 15/755,190

(22) PCT Filed: Aug. 25, 2015
(86) PCT No.: PCT/US2015/046706

§ 371 Date: Feb. 26, 2018

(51) Int. Cl. F02M 26/19; F02M 26/06; B01F 3/02; B01F 5/04; B01F 5/06

(52) U.S. Cl. CPC F02M 26/19; F02M 26/06; B01F 3/02; F02B 29/0406; B01F 5/0473; B01F 5/0647; B01F 5/0486

(57) ABSTRACT

A number of variations may include a product including a mixing device comprising a housing including a first fluid intake port, a fluid output port, a fluid flow conduit transversely connecting the first fluid intake port to the fluid output port, a second fluid intake port radially distal from the fluid flow conduit, and an at least partially annular second fluid flow compartment radially connecting the second fluid intake port to the fluid flow conduit, wherein the second fluid flow compartment is oriented to at least partially surround a portion of the fluid flow conduit and wherein the second fluid flow compartment is constructed and arranged to facilitate the mixing of incoming first fluid flow and incoming second fluid flow to create a fluid mixture that flows through the fluid flow conduit.

### TECHNICAL FIELD

The field to which the disclosure generally relates to includes flow control mechanisms including, but not limited to, mixing devices.

### BACKGROUND

In a number of variations, engine systems may include exhaust gas recirculation systems to optimize engine system performance.

### SUMMARY OF ILLUSTRATIVE VARIATIONS

A number of variations may include a product comprising: a mixing device comprising a housing including a first fluid intake port, a fluid output port, a fluid flow conduit transversely connecting the first fluid intake port to the fluid output port, a second fluid intake port radially distal from the fluid flow conduit, and an at least partially annular second fluid flow compartment radially connecting the second fluid intake port to the fluid flow conduit, wherein the second fluid flow compartment may be oriented to at least partially surround a portion of the fluid flow conduit and wherein the second fluid flow compartment may be constructed and arranged to facilitate the mixing of incoming first fluid flow and incoming second fluid flow to create a fluid mixture that flows through the fluid flow conduit.

A number of variations may include an EGR system comprising: a compressor and a mixing device comprising a housing including an air intake port, a mixed air/exhaust output port, a fluid flow conduit transversely connecting the air intake port to the mixed air/exhaust output port, an exhaust gas intake port radially distal from the fluid flow conduit, and an at least partially annular exhaust gas flow compartment radially connecting the exhaust gas intake port to the fluid flow conduit, wherein the exhaust gas flow compartment may be oriented to at least partially surround a portion of the fluid flow conduit and wherein the exhaust gas flow compartment may be constructed and arranged to facilitate incoming exhaust gas flow and incoming air flow to create a substantially uniform exhaust gas and air mixture that flows through the mixed air/exhaust output port and into the compressor and to facilitate condensation of liquid from the exhaust gas and air mixture as said mixture flows through the fluid flow conduit.

A number of variations may include a method comprising: providing a compressor comprising a turbine and a mixing device comprising a housing including an air intake port, a mixed air/exhaust output port, a fluid flow conduit transversely connecting the air intake port to the mixed air/exhaust output port, an exhaust gas intake port radially distal from the fluid flow conduit, and an at least partially annular exhaust gas flow compartment radially connecting the exhaust gas intake port to the fluid flow conduit, wherein the exhaust gas flow compartment may be oriented to at least partially surround a portion of the fluid flow conduit; and flowing air and exhaust gas through the mixing device to facilitate a substantially uniform mixture of incoming exhaust gas flow and incoming air flow that flows through the mixed air/exhaust output port and into the compressor turbine and to facilitate condensation of liquid from the exhaust gas and air mixture as said mixture flows through the fluid flow conduit.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a view of a system according to a number of variations.

FIG. 2 is a view of a product according to a number of variations.

FIG. 3 is a graph of optimized and un-optimized flow patterns and fluid mixing in an EGR system according to a number of variations.

FIG. 4 is a latitudinal cross sectional view of a product along line X-X in FIG. 2 according to a number of variations, and a graph of optimized and un-optimized nozzle width over circumference in a product according to a number of variations.

FIG. 5 is a perspective end view and a longitudinal cross sectional view of a product according to a number of variations.

FIG. 6 is longitudinal cross sectional view and a plurality of end views of a set of vanes in the nozzle of a product according to a number of variations.

FIG. 7 is a longitudinal cross sectional view of a product and a system according to a number of variations.

### DETAILED DESCRIPTION OF ILLUSTRATIVE VARIATIONS

The following description of the variations is merely illustrative in nature and is in no way intended to limit the scope of the invention, its application, or uses.

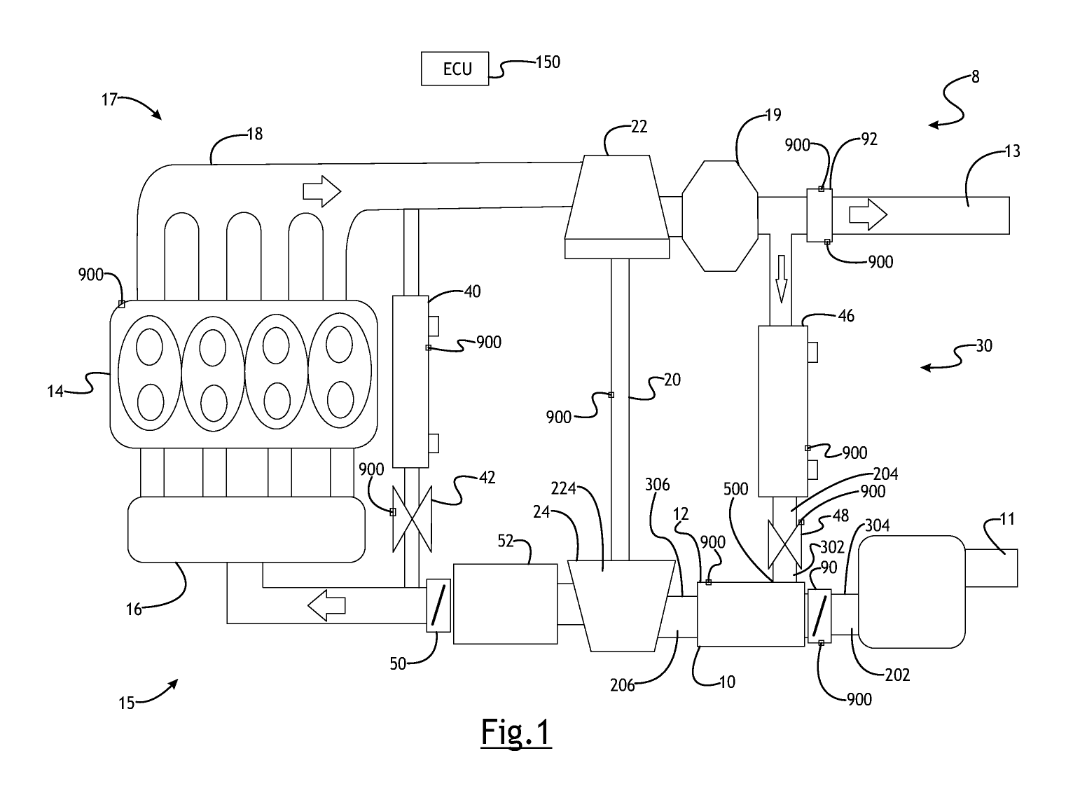

FIG. 1 shows an engine system 8 including a product 10 according to a number of variations. In a number of variations, the engine system 8 may be a part of a vehicle. In a number of variations, the vehicle may include a motor vehicle, watercraft, spacecraft, aircraft, or may be another type. In a number of variations, the engine system 8 may include an engine 14. In a number of variations, the engine 14 may be an internal combustion engine, hybrid engine, or may be another type. In a number of variations, the engine system 8 may have an air intake side 15 comprising an intake manifold 16 for admitting air into the engine 14, an air intake conduit 304, and an air intake port 11. In a number of variations, the engine system 8 may have an exhaust side 17 comprising an exhaust manifold 18 for expelling exhaust gas from the engine 14 and an exhaust port 13. In a number of variations, the exhaust side 17 may include a gasoline particulate filter (GPF) or a diesel particulate filter (DPF) 19. In a number of variations, the exhaust side may include both a GPF and a DPF. In a number of variations, the exhaust side 17 may include neither. In a number of variations, the engine system 8 may include a turbocharger or supercharger 20 comprising at least one of a turbine 22 or a compressor 24. In a number of variations, the compressor 24 may have a compressor housing 224 and a compressor wheel (not shown). In a number of variations, exhaust gases from the exhaust side 17 may be used to drive the turbine 22 that may be connected to, and may drive, the compressor 24. In a number of variations, an electronic control unit (ECU) 150 may monitor and run the engine system 8 based on a number of engine system 8 conditions to meet or optimize a desired engine system 8 application and efficiency. In a number of variations, the exhaust side 17 may include an exhaust flap 92 to allow exhaust gas to escape the engine system 8 based on engine system 8 conditions and may be actuated through the ECU 150. In a number of variations, the air intake side 15 may include a throttle 90. In a number of variations, the throttle 90 may be an inlet swirl throttle 90 to allow incoming air based on engine system 8 conditions and may be actuated through the ECU 150. In a number of variations, the engine system 8 may include an exhaust gas recirculation system (EGR) system 30. In a number of variations, the EGR system 30 and/or turbocharger 20 may be used to selectively recirculate exhaust gas back into the air intake side 15 to provide an air intake into the intake manifold 16 that allows the engine system 8 to run more efficiently. In a number of variations, the EGR system may include at least one exhaust gas recirculation intake conduit 302. In a number of variations, the EGR system 30 may include at least one of the exhaust flap 92 or inlet swirl throttle 90. In a number of variations, the EGR system 30 may include the turbocharger 20 including at least one of the turbine 22 or compressor 24. In a number of variations, the EGR system 30 and/or turbocharger 20, including their components, may be operated and actuated through the ECU 150 to allow incoming air into the intake manifold 16 based on engine system 8 conditions to meet a desired engine system 8 application and efficiency. In a number of variations, the compressor 24 may be driven to compress air in the air intake side 15 into the engine's intake manifold 16. In a number of variations, the EGR system 30 may include at least one of a high pressure EGR cooler 40, a high pressure EGR valve 42, or a high pressure EGR throttle 50. In a number of variations, the EGR system 30 may include a charge air cooler 52. In a number of variations, the EGR system 30 may include at least one of a low pressure EGR cooler 46 or a low pressure EGR valve 48. In a number of variations, the product 10 may be placed upstream of the compressor 24 to provide a compressor inlet conduit 306. In a number of variations, the product 10 may be placed anywhere along the EGR system 30 or engine system 8.

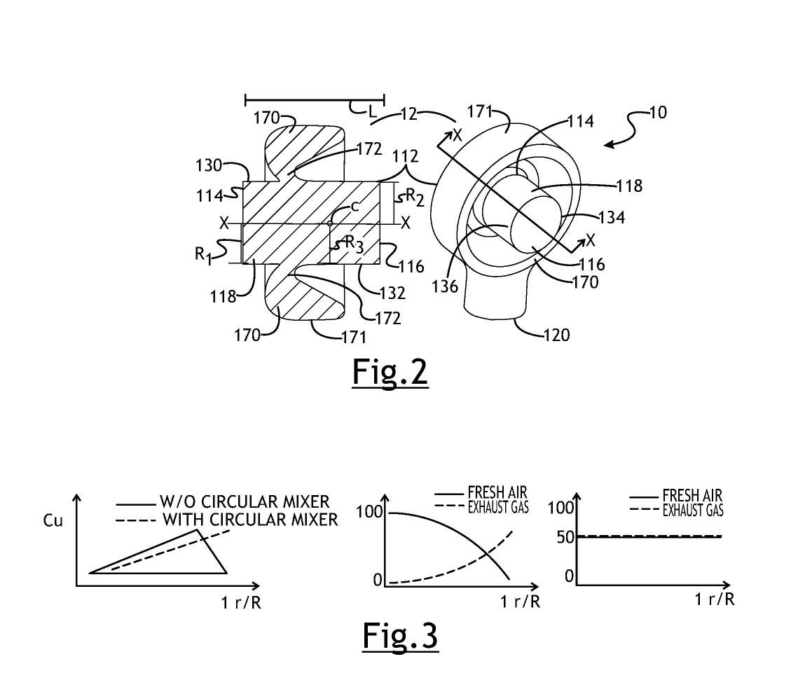

FIG. 2 illustrates a product 10 according to a number of variations. In a number of variations, the product 10 may include a mixing device 12. In a number of variations, the mixing device 12 may mix a plurality of fluids that may include a first fluid 202 and a second fluid 204 to produce a fluid mixture 206. In a number of variations, the first fluid 202 may be air entering the air intake side 15 engine system 8 to feed the air intake manifold 16 of the engine. In a number of variations, the first fluid 202 may include a plurality of fluid components in varying concentrations including, but not limited to, oxygen, carbon dioxide, nitrogen, argon, water, or may be another type. In a number of variations, the second fluid 204 may be exhaust from the exhaust side 17 of the engine system 8 entering the air intake side 15 of the engine system 8 through the EGR system 30 to feed the air intake manifold 16 of the engine. In a number of variations, the second fluid 204 may include a plurality of fluid components in varying concentrations including, but not limited to, volatile organic compounds, hydrocarbons, carbon monoxide, NOₓ, carbon dioxide, formaldehyde, water, particulate matter, nitrogen, oxygen, sulfur dioxide, or may be another type. In a number of variations, the mixing device 12 may include a housing 112. In a number of variations, the housing 112 may include a first fluid intake port 114. In a number of variations, the first fluid intake port 114 may be an air intake port 114. In a number of variations, the first fluid intake port 114 may have a radius R1. In a number of variations, the housing 112 may include a fluid output port 116. In a number of variations, the fluid output port 116 may be a mixed air/exhaust output port 116. In a number of variations, the fluid output port 116 may have a radius R2. In a number of variations, the first fluid intake port 114 may be connected to the fluid output port 116 by a fluid flow conduit 118. In a number of variations, the fluid flow conduit 118 may have a top side 130, a bottom side 132, a right side 134, and a left side 136. In a number of variations, the fluid flow conduit 118 may be tubular. In a number of variations, the fluid flow conduit 118 may be hollow. In a number of variations, the fluid flow conduit 118 may be elliptical. In a number of variations, the fluid flow conduit 118 may be rectangular in cross section. In a number of variations, the fluid flow conduit 118 may be polygonal in cross section. In a number of variations the polygonal cross section may be any hollow 2-dimensional polygon including, but not limited to, triangle, parallelogram, pentagon, hexagon, or may be another type. In a number of variations, the fluid flow conduit 118 may have a radius R3 from a center point C, and a length L. In a number of variations, the fluid flow conduit 118 may run traversely across the width of the mixing device 12. In a number of variations, the radius R3 of the fluid flow conduit 118 may vary along its length L. In a number of variations, the mixing device 12 may include a second fluid intake port 120. In a number of variations, the second fluid intake port 120 may have a radius R4. In a number of variations, the second fluid intake port 120 may be an exhaust gas intake port 120. In a number of variations, the second fluid intake port 120 may be radially distal from the fluid flow conduit 120. In a number of variations, the second fluid intake port 120 may be longitudinally distal from the fluid flow conduit 120. In a number of variations, the mixing device 12 may include second fluid flow compartment 170. In a number of variations, the second fluid flow compartment 170 may be an exhaust gas flow compartment 170. In a number of variations, the second fluid flow compartment 170 may be at least partially annular. In a number of variations, the second fluid flow compartment 170 may comprise an exterior surface 171. In a number of variations, the second fluid flow compartment 170 may connect the second fluid intake port 120 to the fluid flow conduit 118. In a number of variations, the second fluid flow compartment 170 may connect the second fluid intake port 120 to the fluid flow conduit 118 radially around at least a portion of the circumference of the fluid flow conduit 118. In a number of variations, the second fluid flow compartment 170 may be oriented to at least partially surround a portion of the fluid flow conduit 118 along its length. In a number of variations, the mixing device 12 may have no volute. In a number of variations, the second fluid flow compartment 170 may be constructed and arranged to facilitate the mixing of incoming first fluid flow and incoming second fluid flow to create a fluid mixture that flows through the fluid flow conduit. In a number of variations, the first fluid 202 may include air. In a number of variations, the second fluid 204 may include exhaust gas. In a number of variations, the flowing of the first fluid 202 and the second fluid 204 through the mixing device 12 may facilitate a substantially uniform fluid mixture 206 of incoming first fluid and second fluid flow that flows through the fluid output port 116. In a number of variations, “uniform” may be defined as having approximately equal parts first fluid 202 and second fluid 204. In a number of variations, the flowrate of the second fluid 204 as a percentage of the flowrate of the first fluid 202 may be less than approximately 50%. In a number of variations, the flowrate of the second fluid 204 as a percentage of the flowrate of the fluid mixture 206 may be approximately 0%≥x≥80%.

FIG. 3 shows a non-limiting example of non-uniform and uniform flow in the EGR system 30 with and without the mixing device 12, resulting in optimized and unoptimized mixing of first fluid 202 (air) and second fluid 204 (exhaust). As shown in FIG. 3, unoptimized mixing provides uneven mixture concentrations of air 202 and exhaust 204 within a cross-section of the fluid output port 118, evaluated over the non-dimensional radius ratio r/R where r is the actual radius of the fluid flow conduit 118 and R is the port radius at the fluid output port 116. FIG. 3 also shows a non-limiting example of optimized and unoptimized flow pattern into a compressor 24 in the EGR system 30 with and without the mixing device 12 within a cross-section of the fluid output port 118, evaluated over the non-dimensional radius ratio r/R where r is the actual radius of the fluid flow conduit 118 and R is the port radius at the fluid output port 116. In a number of variations, the product 10 and/or mixing device 12 may be included in the EGR system 30 to help provide more optimized mixing device 12 efficiency. In a number of variations, the mixing device 12 may provide uniform flow in the EGR system through uniformity of mixture of the first fluid 202 and second fluid 204 into the fluid mixture 206. In a number of variations, the circumferential mixing of the first fluid 202 and second fluid 204 provided by the circumferential second fluid flow compartment 170 may provide a first fluid 202 concentration higher at the center of the fluid flow conduit 118 and a second fluid 204 concentration higher at the walls of the fluid flow conduit 118. In a number of variations, the mixing device 12 may provide uniform flow in the EGR system through uniformity of speed of the first fluid 202 and second fluid 204 into the fluid mixture 206. In a number of variations, flow speed profile at the first fluid intake port 118 and the second fluid intake port 120 may include an axial, circumferential, and radial component. In a number of variations, a certain amount of the circumferential component (swirl) may be induced in the mixing device 12 or may be self-induced through the geometry of the mixing device 12. In a number of variations, as shown in FIG. 3, the circumferential component (Cu) of the fluid mixture 206 may decrease without a circular mixer 12 at higher levels of r/R. In a number of variations, more optimized mixing device 12 efficiency may help optimize the concentration of exhaust gas and air into the compressor 24 and may help provide a substantially uniform mixture of exhaust gas and air to maximize engine system 8 efficiency. In a number of variations, more optimized mixture 12 efficiency may help increase the flow rate of the exhaust gas recirculated into the air intake side 15. In a number of variations, optimizing mixing device 12 efficiency may contribute to maximization of engine system 8 efficiency. In a number of variations, the ECU 150 may control flowrate of the first fluid 202, second fluid 204, or both through the mixing device 12 to help optimize mixing device 12 mixing quality and in turn help maximize engine system 8 efficiency according to the engine system's 8 desired application or mode.

In a number of variations, the EGR system 30 or mixing device 12 may help maximize engine system 8 efficiency by helping to optimize the mixture of exhaust gas and air to minimize condensation on the compressor 24 by moving the mixing of gas and air upstream of the compressor 24. In a number of variations, the mixing device 12 may provide a contact surface between the second fluid 204 and the first fluid 202 that is reduced causing condensation of humidity to be reduced. In a number of variations, the mixing device 12 may help facilitate condensation of liquid from the exhaust gas and air mixture as said mixture flows through the fluid flow conduit 118, which may help prevent condensation from being formed on or in the compressor 24. In a number of variations, the EGR system 30 or mixing device 12 may help maximize engine system 8 durability (for non-limiting example, compressor 24 durability) by more evenly distributing exhaust gas flow at a compressor inlet. In a number of variations, the EGR system 30 or mixing device 12 be controlled by the ECU 150 such that the flow capacity of the exhaust gas recirculated into the air intake side 15 be optimized to help maximize engine system 8 efficiency by limiting backpressure and energy/pressure losses, and help optimize the natural driving ΔP of exhaust gas from the exhaust side 17 to the air intake side 15 to help maximize engine system 8 efficiency. In a number of variations, the EGR system 30 or mixing device 12 may be controlled by the ECU 150 such that the flow capacity of the exhaust gas recirculated into the air intake side 15 may be optimized to help minimize engine pumping work done on the exhaust gas to help maximize engine system 8 efficiency. In a number of variations, use of the EGR system 30 or mixing device 12 in a vehicle may provide reduced brake specific fuel consumption (BSFC).

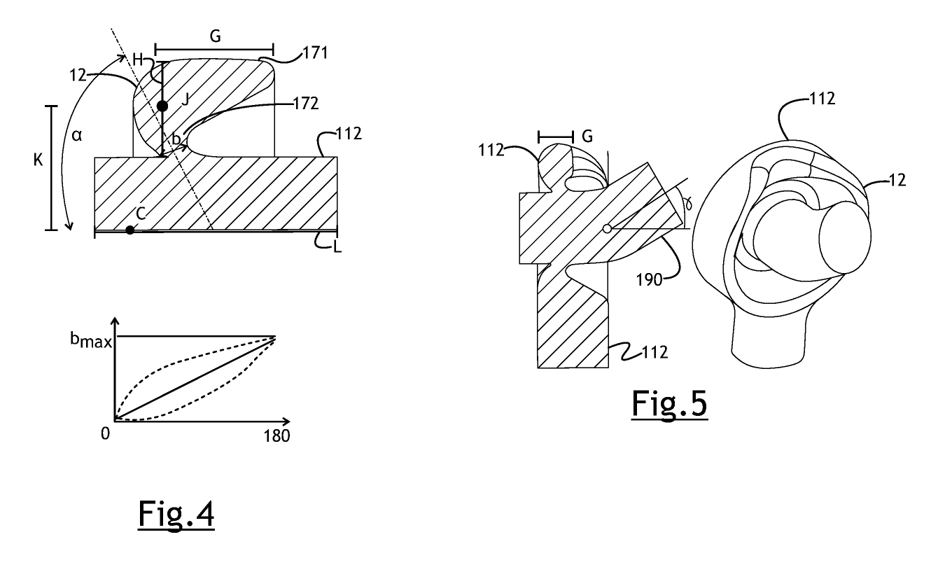

In a number of variations, the second fluid flow compartment 170 may include a nozzle 172. In a number of variations, the nozzle 172 may control flow of the second fluid 204 into the fluid flow conduit 118. In a number of variations, as shown in FIG. 4, the nozzle 172 may have a width b. In a number of variations, as shown in FIG. 4, the nozzle 172 width b may form an angle α in relation to flow with a bisection of the fluid flow conduit 118 at its center point C. In a number of variations, the angle α may range between 0°≥α≥180°. In a number of variations, the angle α, the width b, or both may be varied along the circumference of the second fluid flow compartment 170 to help optimize mixing device 12 mixing quality and in turn help maximize engine system 8 efficiency according to the engine system's 8 desired application or mode. In a number of variations, the ratio of nozzle 172 cross-sectional area in relation to second fluid intake port 120 cross-sectional area may be 75%+/−25%. In a number of variations, as shown in FIG. 4, the second fluid flow compartment 170 may have a width G along its exterior surface. In a number of variations, as shown in FIG. 4, the second fluid flow compartment 170 may have a cross-sectional area A defined as the area from the nozzle b to the exterior surface with a midpoint J. In a number of variations, the mixing device 12 may have a radius K from the center point C of the fluid flow conduit 118 to the midpoint J of the cross-sectional area A of the second fluid flow compartment 170. In a number of variations, the ratio of A/R over circumference should not exceed +/−0.25.

In a number of variations, as shown in FIG. 5, the second fluid flow compartment 170 may include a tongue portion 180. In a number of variations, the tongue portion 180 may include a region of decreased volume in the second fluid flow compartment 170 relative to the non-tongue portion of the second fluid flow compartment 170. In a number of variations, the width G of the second fluid flow compartment 170 along its exterior surface 171 may be decreased in the tongue portion 180. In a number of variations, as shown in FIG. 5, the fluid flow conduit 170 may include a bend 190 between the exterior surface of the second fluid flow compartment 171 and the fluid output port 116. In a number of variations, the bend 190 may have an angle γ in relation to flow with a bisection of the fluid flow conduit 118 at its center point C. In a number of variations, the angle γ may range between 0°≥α≥180°. In a number of variations, the bend 190 and angle γ may be oriented to help optimize mixing device 12 mixing quality and in turn help maximize engine system 8 efficiency according to the engine system's 8 desired application or mode.

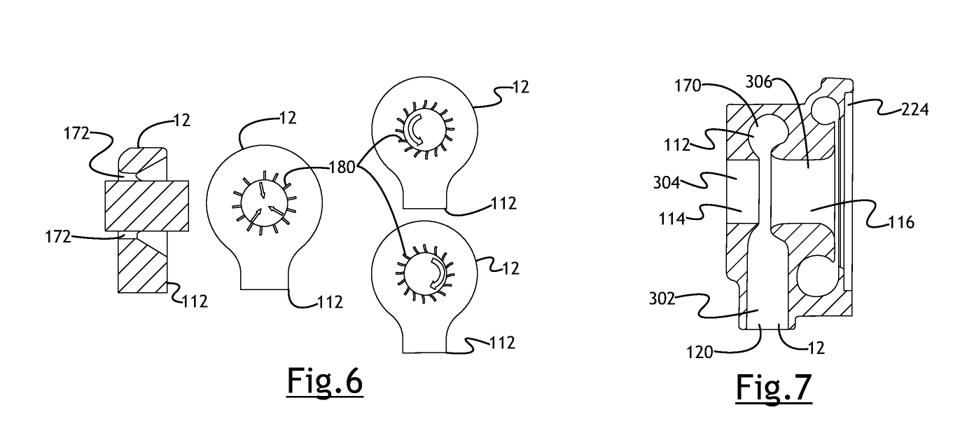

In a number of variations, as shown in FIG. 6, the nozzle 172 may include at least one vane 180. In a number of variations, the nozzle 172 may include a plurality of vanes 180. In a number of variations, the vanes 180 may be oriented to allow the second fluid 204 to flow in a straight ahead pattern as shown in Configuration X of FIG. 6. In a number of variations, the vanes 180 may be oriented to allow the second fluid 204 to flow in a swirl counter-clockwise pattern as shown in Configuration Y of FIG. 6. In a number of variations, the vanes 180 may be oriented to allow the second fluid 204 to flow in a swirl clockwise pattern as shown in Configuration Z of FIG. 6. In a number of variations, the vanes 180 may be oriented to help optimize mixing device 12 mixing quality and in turn help maximize engine system 8 efficiency according to the engine system's 8 desired application or mode. In a number of variations, the vanes 180 of the mixing device 12 may help maximize engine system 8 durability (for example, compressor 24 durability) by more evenly distributing exhaust gas flow at a compressor inlet. In a number of variations, the vanes 180 may allow circumferential slots to guide flow of the second fluid 204 to allow for the more even flow distribution into the first fluid 202 stream to mix into the fluid mixture 206

In a number of variations, as shown in FIG. 1, the product 10, which may include the mixing device 12, may be used as an intersection or junction 500 between the exhaust gas recirculation intake conduit 302 and the air intake conduit 304. In a number of variations, the mixing device 12 housing 112 may be incorporated with the LP-EGR valve 48, inlet swirl throttle 90, or both to form an intersection 500. In a number of variations, as shown in FIG. 7, the mixing device 12 housing 112 may be incorporated or integrated with the compressor 24. In a number of variations, as shown in FIG. 7, the fluid output port 116 may be incorporated into the same housing as the compressor inlet conduit 306. In a number of variations, as shown in FIG. 7, the first fluid intake port 114 may be incorporated into the same housing as the air intake conduit 304. In a number of variations, as shown in FIG. 7, the second fluid intake port 120 may be incorporated into the same housing as the exhaust gas recirculation intake conduit 302. In a number of variations, as shown in FIG. 7, the fluid output port 116 may be attached to the compressor housing 224 to feed the fluid mixture 206 directly into the compressor wheel of the compressor 24. In a number of variations, as shown in FIG. 7, the fluid output port 116 may be incorporated into the compressor housing 224 to feed the fluid mixture 206 directly into the compressor wheel of the compressor 24. In a number of variations, at least one of the fluid output port 116, compressor intake conduit 306, or compressor housing 224 may be attached by an adhesive, rivet, bolt, weld, or through mutual formation, or may be attached together a different way. In a number of variations, the mixing device 12 may maintain the flow direction or swirl of the first fluid 202 from the inlet swirl throttle 90. In a number of variations, the mixing device 12 may be located upstream of the swirl throttle 90 near the air intake port 11. In a number of variations, the mixing device 12 may be located upstream of the LP-EGR valve 48 and downstream of the LP-EGR cooler 46. In a number of variations, the mixing device 12 may be located downstream of the LP-EGR valve 48 and upstream of the LP-EGR cooler 46.

In a number of variations, the ECU 150 may receive and process input from any component within the engine system 8 or EGR system 30 through at least one sensor device 900 in light of stored instructions and/or data, determine a condition through at least one calculation, and transmit output signals to various actuators, including, but not limited to, the mixing device 12, the LP-EGR valve 48, inlet swirl throttle 90, the HP-EGR valve 42, the HP-EGR throttle 50, or the engine 14 itself. In a number of variations, the data acquisition module ECU 150 may include, for example, an electrical circuit, an electronic circuit or chip, and/or a computer. In an illustrative computer variation, ECU 150 generally may include one or more processors, or memory storage units that may be coupled to the processor(s), and one or more interfaces electrically coupling the processor(s) to one or more other devices, including at least one of the mixing device 12, the LP-EGR valve 48, inlet swirl throttle 90, the HP-EGR valve 42, the HP-EGR throttle 50, or the engine 14 itself, or to a different component of a vehicle. The processor(s) and other powered system devices or to the at least one sensor device 900 may be supplied with electricity by a power supply, for example, a battery, other fuel cells, a vehicle engine 14, other vehicle power component, or the like. The processor(s) may execute instructions or calculations that provide at least some of the functionality for the sensor device 900 and method 800. As used herein, the term instructions may include, for example, control logic, computer software and/or firmware, programmable instructions, or other suitable instructions. The processor may include, for example, one or more microprocessors, microcontrollers, application specific integrated circuits, programmable logic devices, field programmable gate arrays, and/or any other suitable type of electronic processing device(s).

Also, in a number of variations, the ECU 150 may be configured to provide storage for data received by the at least one sensor device 900 monitoring the mixing device 12, the LP-EGR valve 48, inlet swirl throttle 90, the HP-EGR valve 42, the HP-EGR throttle 50, or the engine 14 itself, or to a different component of a vehicle, or the like, for processor-executable instructions or calculations. The data, calculations, and/or instructions may be stored, for example, as look-up tables, formulas, algorithms, maps, models, and/or any other suitable format. The memory may include, for example, RAM, ROM, EPROM, and/or any other suitable type of storage article and/or device.

Further, in a number of variations, the interfaces may include, for example, analog/digital or digital/analog converters, signal conditioners, amplifiers, filters, other electronic devices or software modules, and/or any other suitable interfaces. The interfaces may conform to, for example, RS-232, parallel, small computer system interface, universal serial bus, CAN, MOST, LIN, FlexRay, and/or any other suitable protocol(s). The interfaces may include circuits, software, firmware, or any other device to assist or enable the ECU 150 in communicating with the sensors 900 or devices of the engine system 8 or EGR system 30.

In a number of variations, the methods or parts thereof may be implemented in a computer program product including instructions or calculations carried on a computer readable medium for use by one or more processors to implement one or more of the method steps or instructions. The computer program product may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program may be executed on one processor or on multiple processors in communication with one another.

In a number of variations, the program(s) can be embodied on computer readable media, which can include one or more storage devices, articles of manufacture, or the like. Illustrative computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium also may include computer to computer connections, for example, when data may be transferred or provided over a network or another communications connection (either wired, wireless, or a combination thereof). Any combination(s) of the above examples is also included within the scope of the computer-readable media. It is therefore to be understood that the method may be at least partially performed by any electronic articles and/or devices capable of executing instructions corresponding to one or more steps of the disclosed methods.

In a number of variations, a method 800 is shown. In a number of variations, the method 800 may include a step 802 of providing a compressor 24 comprising a turbine and a mixing device 12 comprising a housing 112 including an air intake port 114, a mixed air/exhaust output port 116, a fluid flow conduit 118 transversely connecting the air intake port 114 to the mixed air/exhaust output port 116, an exhaust gas intake port 120 radially distal from the fluid flow conduit 118, and an at least partially annular exhaust gas flow compartment 170 radially connecting the exhaust gas intake port 120 to the fluid flow conduit 118, wherein the exhaust gas flow compartment 120 may be oriented to at least partially surround a portion of the fluid flow conduit 118. In a number of variations, the method 800 may include a step 802 of flowing air 202 and exhaust gas 204 through the mixing device 12 to facilitate a substantially uniform mixture of incoming exhaust gas 204 flow and incoming air flow 202 that flows through the mixed air/exhaust output port 116 and into the compressor 24 turbine and to facilitate condensation of liquid from the exhaust gas and air mixture as said mixture flows through the fluid flow conduit 118.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product that may include a mixing device comprising a housing including a first fluid intake port, a fluid output port, a fluid flow conduit transversely connecting the first fluid intake port to the fluid output port, a second fluid intake port radially distal from the fluid flow conduit, and an at least partially annular second fluid flow compartment radially connecting the second fluid intake port to the fluid flow conduit, wherein the second fluid flow compartment is oriented to at least partially surround a portion of the fluid flow conduit and wherein the second fluid flow compartment is constructed and arranged to facilitate the mixing of incoming first fluid flow and incoming second fluid flow to create a fluid mixture that flows through the fluid flow conduit.

Variation 2 may include a product as set forth in Variation 1 wherein the second fluid flow compartment comprises a nozzle portion which provides controlled flow of the second fluid into the fluid flow conduit.

Variation 3 may include a product as set forth in any of Variations 1-2 wherein the second fluid flow compartment further comprises a tongue portion comprising a region of decreased volume relative to a non-tongue portion of the second fluid flow compartment.

Variation 4 may include a product as set forth in any of Variations 1-3 wherein the first fluid comprises air and/or the second fluid comprises exhaust gas.

Variation 5 may include a product as set forth in any of Variations 1-4 wherein the mixing device is integrated into a compressor of a vehicle exhaust gas recirculation system.

Variation 6 may include a product as set forth in any of Variations 1-5 wherein the mixing device further comprises a bend in the fluid flow conduit.

Variation 7 may include a product as set forth in any of Variations 2-6 wherein the ratio of nozzle area in relation to second fluid intake port area is 75%+/−25%.

Variation 8 may include a product as set forth in any of Variations 2-7 wherein the nozzle width varies along the second fluid flow compartment.

Variation 9 may include a product as set forth in any of Variations 9-8 wherein the nozzle comprises at least one vane to orient flow direction of the second fluid.

Variation 10 may include a EGR system that may include a compressor and a mixing device comprising a housing including an air intake port, a mixed air/exhaust output port, a fluid flow conduit transversely connecting the air intake port to the mixed air/exhaust output port, an exhaust gas intake port radially distal from the fluid flow conduit, and an at least partially annular exhaust gas flow compartment radially connecting the exhaust gas intake port to the fluid flow conduit, wherein the exhaust gas flow compartment is oriented to at least partially surround a portion of the fluid flow conduit and wherein the exhaust gas flow compartment is constructed and arranged to facilitate incoming exhaust gas flow and incoming air flow to create a substantially uniform exhaust gas and air mixture that flows through the mixed air/exhaust output port and into the compressor and to facilitate condensation of liquid from the exhaust gas and air mixture as said mixture flows through the fluid flow conduit.

Variation 11 may include a EGR system as set forth in Variation 10 wherein the exhaust gas flow compartment comprises a nozzle portion which provides controlled flow of the exhaust gas into the fluid flow conduit.

Variation 12 may include a EGR system as set forth in any of Variations 10-11 wherein the exhaust flow compartment further comprises a tongue portion comprising a region of decreased volume relative to a non-tongue portion of the exhaust flow compartment.

Variation 13 may include a EGR system as set forth in any of Variations 10-12 wherein the mixing device is integrated into the compressor.

Variation 14 may include a method that may include EGR system as set forth in any of Variations 10-13 wherein the mixing device further comprises a bend in the fluid flow conduit.

Variation 15 may include a EGR system as set forth in any of Variations 11-14 wherein the ratio of nozzle area in relation to second fluid intake port area is 75%+/−25%.

Variation 16 may include a EGR system as set forth in any of Variations 11-15 wherein the nozzle width varies along the second fluid flow compartment.

Variation 17 may include a EGR system as set forth in any of Variations 11-16 wherein the nozzle comprises at least one vane to orient flow direction of the exhaust gas.

Variation 18 may include a method that may include providing a compressor comprising a turbine and a mixing device comprising a housing including an air intake port, a mixed air/exhaust output port, a fluid flow conduit transversely connecting the air intake port to the mixed air/exhaust output port, an exhaust gas intake port radially distal from the fluid flow conduit, and an at least partially annular exhaust gas flow compartment radially connecting the exhaust gas intake port to the fluid flow conduit, wherein the exhaust gas flow compartment is oriented to at least partially surround a portion of the fluid flow conduit; and flowing air and exhaust gas through the mixing device to facilitate a substantially uniform mixture of incoming exhaust gas flow and incoming air flow that flows through the mixed air/exhaust output port and into the compressor turbine and to facilitate condensation of liquid from the exhaust gas and air mixture as said mixture flows through the fluid flow conduit.

Variation 19 may include a method as set forth in Variation 18 wherein the exhaust gas flow compartment comprises a nozzle portion which provides controlled flow of the exhaust gas into the fluid flow conduit.

Variation 20 may include a method as set forth in any of Variations 18-19 wherein the mixing device is integrated into the compressor.

The above description of select variations within the scope of the invention is merely illustrative in nature and, thus, variations or variants thereof are not to be regarded as a departure from the spirit and scope of the invention.

What is claimed is:

1. A product comprising:
a mixing device comprising a housing including a first fluid intake port, a fluid output port, a fluid flow conduit transversely connecting the first fluid intake port to the fluid output port, a second fluid intake port radially distal from the fluid flow conduit, and an at least partially annular second fluid flow compartment radially connecting the second fluid intake port to the fluid flow conduit, wherein the second fluid flow compartment is oriented to at least partially surround a portion of the fluid flow conduit and wherein the second fluid flow compartment is constructed and arranged to facilitate the mixing of incoming first fluid flow and incoming second fluid flow to create a fluid mixture that flows through the fluid flow conduit.

2. A product as set forth in claim 1 wherein the second fluid flow compartment comprises a nozzle portion which provides controlled flow of the second fluid into the fluid flow conduit.

3. A product as set forth in claim 1 wherein the second fluid flow compartment further comprises a tongue portion comprising a region of decreased volume relative to a non-tongue portion of the second fluid flow compartment.

4. A product as set forth in claim 1 wherein the first fluid comprises air and/or the second fluid comprises exhaust gas.

5. A product as set forth in claim 1 wherein the mixing device is integrated into a compressor of a vehicle exhaust gas recirculation system.

6. The product as set forth in claim 1 wherein the mixing device further comprises a bend in the fluid flow conduit.

7. The product as set forth in claim 2 wherein the ratio of nozzle area in relation to second fluid intake port area is 75%+/−25%.

8. The product as set forth in claim 2 wherein the nozzle width varies along the second fluid flow compartment.

9. The product as set forth in claim 2 wherein the nozzle comprises at least one vane to orient flow direction of the second fluid.

10. An EGR system comprising:
a compressor and a mixing device comprising a housing including an air intake port, a mixed air/exhaust output port, a fluid flow conduit transversely connecting the air intake port to the mixed air/exhaust output port, an exhaust gas intake port radially distal from the fluid flow conduit, and an at least partially annular exhaust gas flow compartment radially connecting the exhaust gas intake port to the fluid flow conduit, wherein the exhaust gas flow compartment is oriented to at least partially surround a portion of the fluid flow conduit and wherein the exhaust gas flow compartment is constructed and arranged to facilitate incoming exhaust gas flow and incoming air flow to create a substantially uniform exhaust gas and air mixture that flows through the mixed air/exhaust output port and into the compressor and to facilitate condensation of liquid from the exhaust gas and air mixture as said mixture flows through the fluid flow conduit.

11. A system as set forth in claim 10 wherein the exhaust gas flow compartment comprises a nozzle portion which provides controlled flow of the exhaust gas into the fluid flow conduit.

12. A system as set forth in claim 10 wherein the exhaust flow compartment further comprises a tongue portion comprising a region of decreased volume relative to a non-tongue portion of the exhaust flow compartment.

13. A system as set forth in claim 10 wherein the mixing device is integrated into the compressor.

14. The system as set forth in claim 10 wherein the mixing device further comprises a bend in the fluid flow conduit.

15. The system as set forth in claim 11 wherein the ratio of nozzle area in relation to second fluid intake port area is 75%+/−25%.

16. The system as set forth in claim 11 wherein the nozzle width varies along the second fluid flow compartment.

17. The system as set forth in claim 11 wherein the nozzle comprises at least one vane to orient flow direction of the exhaust gas.

18. A method comprising:
providing a compressor comprising a turbine and a mixing device comprising a housing including an air intake port, a mixed air/exhaust output port, a fluid flow conduit transversely connecting the air intake port to the mixed air/exhaust output port, an exhaust gas intake port radially distal from the fluid flow conduit, and an at least partially annular exhaust gas flow compartment radially connecting the exhaust gas intake port to the fluid flow conduit, wherein the exhaust gas flow compartment is oriented to at least partially surround a portion of the fluid flow conduit; and
flowing air and exhaust gas through the mixing device to facilitate a substantially uniform mixture of incoming exhaust gas flow and incoming air flow that flows through the mixed air/exhaust output port and into the compressor turbine and to facilitate condensation of liquid from the exhaust gas and air mixture as said mixtures flows through the fluid flow conduit.

19. A method as set forth in claim 18 wherein the exhaust gas flow compartment comprises a nozzle portion which provides controlled flow of the exhaust gas into the fluid flow conduit.

20. A method as set forth in claim 18 wherein the mixing device is integrated into the compressor.
